(19) United States
(12) Patent Application Publication
(10) Pub. No.: US 2013/0215100 A1
(43) Pub. Date: Aug. 22, 2013

(54) SYSTEMS AND METHODS FOR MEASURING DIMENSIONS OF AN APARTMENT AND DISPLAYING THE DIMENSIONS IN 3D FORMATS ALLOWING NAVIGATIONS BY USERS OF THE SYSTEM SIMULTANEOUSLY

(71) Applicant: TAI CHEUNG POON, Hong Kong (HK)

(72) Inventor: TAI CHEUNG POON, Hong Kong (HK)

(21) Appl. No.: 13/398,743

(22) Filed: Feb. 16, 2012

(51) Int. Cl. G06T 17/00

(52) U.S. Cl. 345/419

(57) ABSTRACT

This invention is provided to measure dimensions of an apartment and displaying the dimensions in 3D formats allowing navigations by users of the system simultaneously. In one embodiment, a system is provided to include a device for measuring the dimensions of the unit, at least one pair of infrared red emitter and receiver, camera, location detection device, and a set of schematic diagrams. The system is adapted to display the measured dimensions in 2D and 3D images, allowing users to navigate freely.

### FIELD OF THE INVENTION

This invention is generally related to measuring dimensions of more than one enclosed areas. Specifically, but not related to, this invention measures dimensions of rooms of an apartment and provide the dimensions with visual representations to facilitate user experience.

### BACKGROUND OF THE INVENTION

There are plenty of devices to measure distances. In one example, laser beam like products are used frequently by real estate agents to measure the size of an apartment. The short coming of such means is apparent. A user using a laser beam must make several measurements, in order to make measurements of an entire room. The user, must, for example, measure the width of the room first, before starting to measure the rest of the needed dimensions, including the length, and the height of the room. In addition, the user usually must orient the laser beam device in a certain way before measurement can occur. For example, the user must lean the device against one wall before start measuring the distance to the other wall facing. This is highly inconvenient, especially to real estate agents, where timeliness is essential.

### SUMMARY OF THE INVENTION

A system is provided for measuring dimensions of an apartment and displaying the dimensions in 3D formats allowing navigations by users of the system simultaneously. In one embodiment, the system may comprises a device for measuring the dimensions of the unit; a first pair of infrared red emitter and receiver on a first side of the device.

In the embodiment, the distance from the first side of the device to a first wall may be measured by emission and reception between the first pair of infrared red emitter and receiver; a second pair of infrared red emitter and receiver on a second side of the device. The distance from the second side of the device to a second wall can be measured by emission and reception between the second pair of infrared red emitter and receiver; a third pair of infrared red emitter and receiver on a third side of the device, wherein the distance from the third side of the device to a third wall is measured by emission and reception between the third pair of infrared red emitter and receiver; a fourth pair of infrared red emitter and receiver on a fourth side of the device.

Meanwhile, the distance from the fourth side of the device to a fourth wall may be measured by emission and reception between the fourth pair of infrared red emitter and receiver; a fifth pair of infrared red emitter and receiver on a fifth side of the device, wherein the distance from the fifth side of the device to ceiling of the room is measured by emission and reception between the fifth pair of infrared red emitter and receiver; a sixth pair of infrared red emitter and receiver on a sixth side of the device, wherein the distance from the sixth side of the device to floor of the room is measured by emission and reception between the sixth pair of infrared red emitter and receiver; a first camera on the first side of the device; a second camera on the second side of the device; a third camera on the third side of the device; a fourth camera on the fourth side of the device; a fifth camera on the fifth side of the device; a sixth camera on the sixth side of the device; a location detecting device included in the device.

The location detecting device may be adapted to detect current apartment where the device is being located; and detect current room within the current apartment, wherein the current room is where the device is being located within the current apartment; a set of schematic diagrams of apartments in a given area. One of the maps may include layout of the current room and the current apartment; a display configured to display the set of schematic diagrams; a processor; and a memory storing instructions that cause the processor to execute a method.

Further in the embodiment, the method may comprise entering the apartment; detecting location of the apartment by the location detection device; searching for a schematic diagram of the apartment from the set of schematic diagrams based on the detected location of the apartment; displaying the schematic diagram of the apartment; entering a room within the apartment; detecting location of the room by the location detection device; searching for a schematic diagram of the room from the set of schematic diagrams based on the detected location of the apartment; displaying the schematic diagram of the room; upon request, measuring dimensions of the room, wherein the measuring comprises: using the first pair of infrared red emitter and receiver to measure the first wall; using the second pair of infrared red emitter and receiver to measure the second wall simultaneous; using the third pair of infrared red emitter and receiver to measure the third wall simultaneous; using the fourth pair of infrared red emitter and receiver to measure the fourth wall simultaneous; using the fifth pair of infrared red emitter and receiver to measure the ceiling simultaneous; and using the sixth pair of infrared red emitter and receiver to measure the floor simultaneous; based on the measured dimensions, calculating area and height of the room; re-displaying the schematic diagram of the room, the re-displaying including the dimensions of the room; upon request, taking photographs of the room.

The taking of the photographs may comprise using the first camera to take picture of the first wall; using the second camera to take picture of the second wall simultaneously; using the third camera to take picture of the third wall simultaneously; using the fourth camera to take picture of the fourth wall simultaneously; using the fifth camera to take picture of the ceiling simultaneously; using the sixth camera to take picture of the floor simultaneously; re-displaying the room based on the photographs of the room, the re-displaying including the addition of the dimensions of the room; upon request, performing 3D rendering using the photographs of the room; and re-displaying the room based on the 3D rendering of the room, the re-displaying allowing a user to navigate the room.

In an alternative embodiment, the method comprises entering the apartment; detecting location of the apartment by the location detection device; searching for a schematic diagram of the apartment from the set of schematic diagrams based on the detected location of the apartment; displaying the schematic diagram of the apartment; entering a room within the apartment; detecting location of the room by the location detection device; searching for a schematic diagram of the room from the set of schematic diagrams based on the detected location of the apartment; displaying the schematic diagram of the room; upon request, measuring dimensions of the room, wherein the measuring comprises: using the first pair of infrared red emitter and receiver to measure the first wall; using the second pair of infrared red emitter and receiver to measure the second wall simultaneous; using the third pair of infrared red emitter and receiver to measure the third wall simultaneous; using the fourth pair of infrared red emitter and receiver to measure the fourth wall simultaneous; using the fifth pair of infrared red emitter and receiver to measure the ceiling simultaneous; and using the sixth pair of infrared red emitter and receiver to measure the floor simultaneous; based on the measured dimensions, calculating area and height of the room; re-displaying the schematic diagram of the room, the re-displaying including the dimensions of the room; upon request, taking photographs of the room.

The taking of the photographs comprises using the first camera to take picture of the first wall; using the second camera to take picture of the second wall simultaneously; using the third camera to take picture of the third wall simultaneously; using the fourth camera to take picture of the fourth wall simultaneously; using the fifth camera to take picture of the ceiling simultaneously; using the sixth camera to take picture of the floor simultaneously; re-displaying the room based on the photographs of the room, the re-displaying including the addition of the dimensions of the room; upon request, performing 3D rendering using the photographs of the room; and re-displaying the room based on the 3D rendering of the room, the re-displaying allowing the user to navigate the room. entering each of rest of rooms within the apartment; and for each of the room: measuring the dimensions of the room; displaying the room with the dimensions; displaying the room based on the 3D rendering of the room; and allowing the user to navigate the room through the display.

### BRIEF DESCRIPTION OF THE DRAWINGS

FIG. 1 illustrates an exemplary system in accordance to an embodiment of the present invention.

### DETAILED DESCRIPTION

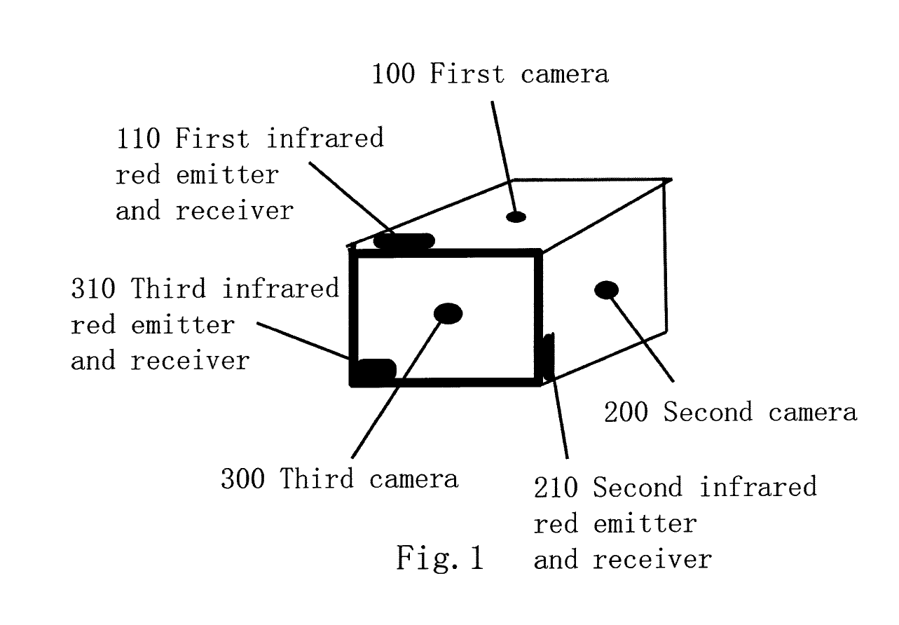

There are a number ways to implement this inventive system. Referring to FIG. 1 for an example of implementation. In the figure, a system for measuring dimensions of an apartment and displaying the dimensions in 3D formats allowing navigations by users of the system simultaneously is provided. The system comprises a device for measuring the dimensions of the unit; a first pair of infrared red emitter and receiver on a first side of the device.

The distance from the first side of the device to a first wall is measured by emission and reception between the first pair of infrared red emitter and receiver; a second pair of infrared red emitter and receiver on a second side of the device, wherein the distance from the second side of the device to a second wall is measured by emission and reception between the second pair of infrared red emitter and receiver; a third pair of infrared red emitter and receiver on a third side of the device, wherein the distance from the third side of the device to a third wall is measured by emission and reception between the third pair of infrared red emitter and receiver; a fourth pair of infrared red emitter and receiver on a fourth side of the device, wherein the distance from the fourth side of the device to a fourth wall is measured by emission and reception between the fourth pair of infrared red emitter and receiver; a fifth pair of infrared red emitter and receiver on a fifth side of the device.

The distance from the fifth side of the device to ceiling of the room is measured by emission and reception between the fifth pair of infrared red emitter and receiver; a sixth pair of infrared red emitter and receiver on a sixth side of the device, wherein the distance from the sixth side of the device to floor of the room is measured by emission and reception between the sixth pair of infrared red emitter and receiver; a first camera on the first side of the device; a second camera on the second side of the device; a third camera on the third side of the device; a fourth camera on the fourth side of the device; a fifth camera on the fifth side of the device; a sixth camera on the sixth side of the device; a location detecting device included in the device, wherein the location detecting device is adapted to: detect current apartment where the device is being located; and detect current room within the current apartment.

The current room is where the device is being located within the current apartment. Included is a set of schematic diagrams of apartments in a given area, wherein one of the maps includes layout of the current room and the current apartment; a display configured to display the set of schematic diagrams; a processor; and a memory storing instructions that cause the processor to execute a method, the method comprising: entering the apartment; detecting location of the apartment by the location detection device; searching for a schematic diagram of the apartment from the set of schematic diagrams based on the detected location of the apartment; displaying the schematic diagram of the apartment; entering a room within the apartment; detecting location of the room by the location detection device; searching for a schematic diagram of the room from the set of schematic diagrams based on the detected location of the apartment; displaying the schematic diagram of the room; upon request, measuring dimensions of the room, wherein the measuring comprises: using the first pair of infrared red emitter and receiver to measure the first wall; using the second pair of infrared red emitter and receiver to measure the second wall simultaneous; using the third pair of infrared red emitter and receiver to measure the third wall simultaneous; using the fourth pair of infrared red emitter and receiver to measure the fourth wall simultaneous; using the fifth pair of infrared red emitter and receiver to measure the ceiling simultaneous; and using the sixth pair of infrared red emitter and receiver to measure the floor simultaneous; based on the measured dimensions, calculating area and height of the room; re-displaying the schematic diagram of the room, the re-displaying including the dimensions of the room; upon request, taking photographs of the room. The taking of the photographs comprises: using the first camera to take picture of the first wall; using the second camera to take picture of the second wall simultaneously; using the third camera to take picture of the third wall simultaneously; using the fourth camera to take picture of the fourth wall simultaneously; using the fifth camera to take picture of the ceiling simultaneously; using the sixth camera to take picture of the floor simultaneously; re-displaying the room based on the photographs of the room, the re-displaying including the addition of the dimensions of the room; upon request, performing 3D rendering using the photographs of the room; and re-displaying the room based on the 3D rendering of the room, the re-displaying allowing a user to navigate the room.

In a different implementation, the exemplary system may include a device for measuring the dimensions of the unit; a first pair of infrared red emitter and receiver on a first side of the device, wherein the distance from the first side of the device to a first wall is measured by emission and reception between the first pair of infrared red emitter and receiver; a second pair of infrared red emitter and receiver on a second side of the device.

Here, the distance from the second side of the device to a second wall is measured by emission and reception between the second pair of infrared red emitter and receiver; a third pair of infrared red emitter and receiver on a third side of the device, wherein the distance from the third side of the device to a third wall is measured by emission and reception between the third pair of infrared red emitter and receiver; a fourth pair of infrared red emitter and receiver on a fourth side of the device, wherein the distance from the fourth side of the device to a fourth wall is measured by emission and reception between the fourth pair of infrared red emitter and receiver; a fifth pair of infrared red emitter and receiver on a fifth side of the device, wherein the distance from the fifth side of the device to ceiling of the room is measured by emission and reception between the fifth pair of infrared red emitter and receiver; a sixth pair of infrared red emitter and receiver on a sixth side of the device.

The distance from the sixth side of the device to floor of the room, meanwhile, is measured by emission and reception between the sixth pair of infrared red emitter and receiver; a first camera on the first side of the device; a second camera on the second side of the device; a third camera on the third side of the device; a fourth camera on the fourth side of the device; a fifth camera on the fifth side of the device; a sixth camera on the sixth side of the device; a location detecting device included in the device, wherein the location detecting device is adapted to: detect current apartment where the device is being located; and detect current room within the current apartment, wherein the current room is where the device is being located within the current apartment; a set of schematic diagrams of apartments in a given area, wherein one of the maps includes layout of the current room and the current apartment; a display configured to display the set of schematic diagrams; a processor; and a memory storing instructions that cause the processor to execute a method. The method comprises entering the apartment; detecting location of the apartment by the location detection device; searching for a schematic diagram of the apartment from the set of schematic diagrams based on the detected location of the apartment; displaying the schematic diagram of the apartment; entering a room within the apartment; detecting location of the room by the location detection device; searching for a schematic diagram of the room from the set of schematic diagrams based on the detected location of the apartment; displaying the schematic diagram of the room; upon request, measuring dimensions of the room, wherein the measuring comprises: using the first pair of infrared red emitter and receiver to measure the first wall; using the second pair of infrared red emitter and receiver to measure the second wall simultaneous; using the third pair of infrared red emitter and receiver to measure the third wall simultaneous; using the fourth pair of infrared red emitter and receiver to measure the fourth wall simultaneous; using the fifth pair of infrared red emitter and receiver to measure the ceiling simultaneous; and using the sixth pair of infrared red emitter and receiver to measure the floor simultaneous; based on the measured dimensions, calculating area and height of the room; re-displaying the schematic diagram of the room, the re-displaying including the dimensions of the room; upon request, taking photographs of the room, wherein the taking of the photographs comprises: using the first camera to take picture of the first wall; using the second camera to take picture of the second wall simultaneously; using the third camera to take picture of the third wall simultaneously; using the fourth camera to take picture of the fourth wall simultaneously; using the fifth camera to take picture of the ceiling simultaneously; using the sixth camera to take picture of the floor simultaneously; re-displaying the room based on the photographs of the room, the re-displaying including the addition of the dimensions of the room; upon request, performing 3D rendering using the photographs of the room; and re-displaying the room based on the 3D rendering of the room, the re-displaying allowing the user to navigate the room. entering each of rest of rooms within the apartment; and for each of the room: measuring the dimensions of the room; displaying the room with the dimensions;

displaying the room based on the 3D rendering of the room; and allowing the user to navigate the room through the display.

In yet another implementation, the inventive system for measuring dimensions of an apartment and displaying the dimensions in 3D formats allowing navigations by users of the system simultaneously, comprising a device for measuring the dimensions of the unit; a first pair of infrared red emitter and receiver on a first side of the device, wherein the distance from the first side of the device to a first wall is measured by emission and reception between the first pair of infrared red emitter and receiver; a second pair of infrared red emitter and receiver on a second side of the device, wherein the distance from the second side of the device to a second wall is measured by emission and reception between the second pair of infrared red emitter and receiver; a third pair of infrared red emitter and receiver on a third side of the device.

The distance from the third side of the device to a third wall is measured by emission and reception between the third pair of infrared red emitter and receiver; a fourth pair of infrared red emitter and receiver on a fourth side of the device, wherein the distance from the fourth side of the device to a fourth wall is measured by emission and reception between the fourth pair of infrared red emitter and receiver; a fifth pair of infrared red emitter and receiver on a fifth side of the device, wherein the distance from the fifth side of the device to ceiling of the room is measured by emission and reception between the fifth pair of infrared red emitter and receiver; a sixth pair of infrared red emitter and receiver on a sixth side of the device.

The distance from the sixth side of the device to floor of the room is measured by emission and reception between the sixth pair of infrared red emitter and receiver; a first camera on the first side of the device; a second camera on the second side of the device; a third camera on the third side of the device; a fourth camera on the fourth side of the device; a fifth camera on the fifth side of the device; a sixth camera on the sixth side of the device; a location detecting device included in the device, wherein the location detecting device is adapted to: detect current apartment where the device is being located; and detect current room within the current apartment, wherein the current room is where the device is being located within the current apartment; a set of schematic diagrams of apartments in a given area, wherein one of the maps includes layout of the current room and the current apartment; a display configured to display the set of schematic diagrams; a processor; and a memory storing instructions that cause the processor to execute a method, the method comprising: entering the apartment; detecting location of the apartment by the location detection device; searching for a schematic diagram of the apartment from the set of schematic diagrams based on the detected location of the apartment; displaying the schematic diagram of the apartment; entering a room within the apartment; detecting location of the room by the location detection device; searching for a schematic diagram of the room from the set of schematic diagrams based on the detected location of the apartment; displaying the schematic diagram of the room; upon request, measuring dimensions of the room.

It follows that the measuring comprises using the first pair of infrared red emitter and receiver to measure the first wall; using the second pair of infrared red emitter and receiver to measure the second wall simultaneous; using the third pair of infrared red emitter and receiver to measure the third wall simultaneous; using the fourth pair of infrared red emitter and receiver to measure the fourth wall simultaneous; using the fifth pair of infrared red emitter and receiver to measure the ceiling simultaneous; and using the sixth pair of infrared red emitter and receiver to measure the floor simultaneous; based on the measured dimensions, calculating area and height of the room; re-displaying the schematic diagram of the room, the re-displaying including the dimensions of the room; upon request, taking photographs of the room, wherein the taking of the photographs comprises: using the first camera to take picture of the first wall; using the second camera to take picture of the second wall simultaneously; using the third camera to take picture of the third wall simultaneously; using the fourth camera to take picture of the fourth wall simultaneously; using the fifth camera to take picture of the ceiling simultaneously; using the sixth camera to take picture of the floor simultaneously; re-displaying the room based on the photographs of the room, the re-displaying including the addition of the dimensions of the room; upon request, performing 3D rendering using the photographs of the room; and re-displaying the room based on the 3D rendering of the room, the re-displaying allowing a user to navigate the room. entering each of rest of rooms within the apartment; and for each of the room: measuring the dimensions of the room; displaying the room with the dimensions; displaying the room based on the 3D rendering of the room; and allowing the user to navigate the room through the display; adding the dimensions of each of the rooms to the schematic diagram of the apartment; displaying the schematic diagram of the apartment, where the displaying includes the display of the dimensions of each of the rooms within the apartment; re-displaying the apartment based on the 3D rendering of the room, wherein the re-displaying includes display of the dimensions of each of the rooms within the apartment; which allowing the user to navigate between rooms through the display.

What is claimed is:

1. A system for measuring dimensions of an apartment and displaying the dimensions in 3D formats allowing navigations by users of the system simultaneously, comprising:
a device for measuring the dimensions of the unit;
a first pair of infrared red emitter and receiver on a first side of the device, wherein the distance from the first side of the device to a first wall is measured by emission and reception between the first pair of infrared red emitter and receiver;
a second pair of infrared red emitter and receiver on a second side of the device, wherein the distance from the second side of the device to a second wall is measured by emission and reception between the second pair of infrared red emitter and receiver;
a third pair of infrared red emitter and receiver on a third side of the device, wherein the distance from the third side of the device to a third wall is measured by emission and reception between the third pair of infrared red emitter and receiver;
a fourth pair of infrared red emitter and receiver on a fourth side of the device, wherein the distance from the fourth side of the device to a fourth wall is measured by emission and reception between the fourth pair of infrared red emitter and receiver;
a fifth pair of infrared red emitter and receiver on a fifth side of the device, wherein the distance from the fifth side of the device to ceiling of the room is measured by emission and reception between the fifth pair of infrared red emitter and receiver;
a sixth pair of infrared red emitter and receiver on a sixth side of the device, wherein the distance from the sixth side of the device to floor of the room is measured by emission and reception between the sixth pair of infrared red emitter and receiver;
a first camera on the first side of the device;
a second camera on the second side of the device;
a third camera on the third side of the device;
a fourth camera on the fourth side of the device;
a fifth camera on the fifth side of the device;
a sixth camera on the sixth side of the device;
a location detecting device included in the device, wherein the location detecting device is adapted to:
detect current apartment where the device is being located; and
detect current room within the current apartment, wherein the current room is where the device is being located within the current apartment;
a set of schematic diagrams of apartments in a given area, wherein one of the maps includes layout of the current room and the current apartment;
a display configured to display the set of schematic diagrams;
a processor; and
a memory storing instructions that cause the processor to execute a method.

2. The system of claim 1, the method comprising,
entering the apartment;
detecting location of the apartment by the location detection device;
searching for a schematic diagram of the apartment from the set of schematic diagrams based on the detected location of the apartment;
displaying the schematic diagram of the apartment;
entering a room within the apartment;
detecting location of the room by the location detection device;
searching for a schematic diagram of the room from the set of schematic diagrams based on the detected location of the apartment;
displaying the schematic diagram of the room;
upon request, measuring dimensions of the room, wherein the measuring comprises:
using the first pair of infrared red emitter and receiver to measure the first wall;
using the second pair of infrared red emitter and receiver to measure the second wall simultaneous;
using the third pair of infrared red emitter and receiver to measure the third wall simultaneous;
using the fourth pair of infrared red emitter and receiver to measure the fourth wall simultaneous;
using the fifth pair of infrared red emitter and receiver to measure the ceiling simultaneous; and
using the sixth pair of infrared red emitter and receiver to measure the floor simultaneous;
based on the measured dimensions, calculating area and height of the room;
re-displaying the schematic diagram of the room, the re-displaying including the dimensions of the room;
upon request, taking photographs of the room, wherein the taking of the photographs comprises:
using the first camera to take picture of the first wall;
using the second camera to take picture of the second wall simultaneously;
using the third camera to take picture of the third wall simultaneously;
using the fourth camera to take picture of the fourth wall simultaneously;
using the fifth camera to take picture of the ceiling simultaneously;
using the sixth camera to take picture of the floor simultaneously;
re-displaying the room based on the photographs of the room, the re-displaying including the addition of the dimensions of the room;
upon request, performing 3D rendering using the photographs of the room; and
re-displaying the room based on the 3D rendering of the room, the re-displaying allowing a user to navigate the room.

3. The system of claim 1, the method comprising:
entering the apartment;
detecting location of the apartment by the location detection device;
searching for a schematic diagram of the apartment from the set of schematic diagrams based on the detected location of the apartment;
displaying the schematic diagram of the apartment;
entering a room within the apartment;
detecting location of the room by the location detection device;
searching for a schematic diagram of the room from the set of schematic diagrams based on the detected location of the apartment;
displaying the schematic diagram of the room;
upon request, measuring dimensions of the room, wherein the measuring comprises:
using the first pair of infrared red emitter and receiver to measure the first wall;
using the second pair of infrared red emitter and receiver to measure the second wall simultaneous;
using the third pair of infrared red emitter and receiver to measure the third wall simultaneous;
using the fourth pair of infrared red emitter and receiver to measure the fourth wall simultaneous;
using the fifth pair of infrared red emitter and receiver to measure the ceiling simultaneous; and
using the sixth pair of infrared red emitter and receiver to measure the floor simultaneous;
based on the measured dimensions, calculating area and height of the room;
re-displaying the schematic diagram of the room, the re-displaying including the dimensions of the room;
upon request, taking photographs of the room, wherein the taking of the photographs comprises:
using the first camera to take picture of the first wall;
using the second camera to take picture of the second wall simultaneously;
using the third camera to take picture of the third wall simultaneously;
using the fourth camera to take picture of the fourth wall simultaneously;
using the fifth camera to take picture of the ceiling simultaneously;
using the sixth camera to take picture of the floor simultaneously;
re-displaying the room based on the photographs of the room, the re-displaying including the addition of the dimensions of the room;
upon request, performing 3D rendering using the photographs of the room; and
re-displaying the room based on the 3D rendering of the room, the re-displaying allowing the user to navigate the room.
entering each of rest of rooms within the apartment; and
for each of the room:
measuring the dimensions of the room;
displaying the room with the dimensions;
displaying the room based on the 3D rendering of the room; and
allowing the user to navigate the room through the display.

4. The system of claim 1, the method comprising:
entering the apartment;
detecting location of the apartment by the location detection device;
searching for a schematic diagram of the apartment from the set of schematic diagrams based on the detected location of the apartment;
displaying the schematic diagram of the apartment;
entering a room within the apartment;
detecting location of the room by the location detection device;
searching for a schematic diagram of the room from the set of schematic diagrams based on the detected location of the apartment;
displaying the schematic diagram of the room;
upon request, measuring dimensions of the room, wherein the measuring comprises:
using the first pair of infrared red emitter and receiver to measure the first wall;
using the second pair of infrared red emitter and receiver to measure the second wall simultaneous;
using the third pair of infrared red emitter and receiver to measure the third wall simultaneous;
using the fourth pair of infrared red emitter and receiver to measure the fourth wall simultaneous;
using the fifth pair of infrared red emitter and receiver to measure the ceiling simultaneous; and
using the sixth pair of infrared red emitter and receiver to measure the floor simultaneous;
based on the measured dimensions, calculating area and height of the room;
re-displaying the schematic diagram of the room, the re-displaying including the dimensions of the room;
upon request, taking photographs of the room, wherein the taking of the photographs comprises:
using the first camera to take picture of the first wall;
using the second camera to take picture of the second wall simultaneously;
using the third camera to take picture of the third wall simultaneously;
using the fourth camera to take picture of the fourth wall simultaneously;
using the fifth camera to take picture of the ceiling simultaneously;
using the sixth camera to take picture of the floor simultaneously;
re-displaying the room based on the photographs of the room, the re-displaying including the addition of the dimensions of the room;
upon request, performing 3D rendering using the photographs of the room; and
re-displaying the room based on the 3D rendering of the room, the re-displaying allowing a user to navigate the room. entering each of rest of rooms within the apartment; and
for each of the room:
measuring the dimensions of the room;
displaying the room with the dimensions;
displaying the room based on the 3D rendering of the room; and
allowing the user to navigate the room through the display;
adding the dimensions of each of the rooms to the schematic diagram of the apartment;
displaying the schematic diagram of the apartment, where the displaying includes the display of the dimensions of each of the rooms within the apartment;
re-displaying the apartment based on the 3D rendering of the room, wherein the re-displaying includes display of the dimensions of each of the rooms within the apartment; and
allowing the user to navigate between rooms through the display.
